(19) United States
(12) Patent Application Publication
(10) Pub. No.: US 2016/0139742 A1
(43) Pub. Date: May 19, 2016

(54) METHOD FOR MANAGING MEDIA CONTENTS AND APPARATUS FOR THE SAME

(71) Applicant: SAMSUNG ELECTRONICS CO., LTD., Suwon-si, Gyeonggi-do (KR)

(72) Inventors: Dwarkaprasad DAYAMA, Gyeonggi-do (KR); Pankaj AGARWAL, Gyeonggi-do (KR)

(21) Appl. No.: 14/900,031

(22) PCT Filed: Jun. 18, 2014
(86) PCT No.: PCT/KR2014/005379

§ 371 Date: Dec. 18, 2015

(51) Int. Cl. G06F 3/0482; G06F 3/0484

(52) U.S. Cl. CPC G06F 3/0482; G06F 3/04842

(57) ABSTRACT

A method of managing contents is provided. The method includes selecting at least one content; storing the at least one selected content in at least one content sharing server; receiving a user input about the selected contents shared through the content sharing server; and reflecting the user input in the selected contents and displaying the contents.

### PRIORITY

This application is a National Phase Entry of PCT International Application No. PCT/KR2014/005379, which was filed on Jun. 18, 2014, which claims priority to Korean Patent Application Serial No. 10-2013-0069796, which was filed Jun. 18, 2013, the contents of each of which are incorporated herein by reference.

### BACKGROUND

1. Field of the Disclosure

The present disclosure generally relates to a media content managing, and more particularly, to managing and displaying a user input related to media contents.

2. Description of the Related Art

Various services and additional functions provided by terminal apparatuses (particularly, a mobile terminal apparatus) have gradually expanded. In order to increase an effective value of the terminal apparatus and meet various demands of users, various applications executable by the terminal apparatus have been developed.

The terminal apparatus can store and execute basic applications manufactured by the terminal manufacturer and installed in the terminal apparatus, as well as additional applications downloaded from a website selling applications through the Internet. The additional applications may be developed by general developers and registered on the application selling website. Accordingly, anyone can freely sell applications developed by himself/herself to the user of the terminal apparatus through the website selling applications. Therefore, tens of thousands to hundreds of thousands of applications are currently provided to the terminal apparatuses free of charge or at a cost.

Accordingly, the terminal apparatuses provide various useful functions to a user through various applications. Particularly, a social media service function may be an example among the various functions. The social media service enables contents to be shared between users of terminal apparatuses through various schemes.

Generally, a social media service stores media contents which a user requests to share in a service server providing a social media service as described above and configures another user allowed to share the media contents, so as to allow the users to share media contents with each other.

### SUMMARY

The present disclosure has been made to address at least the above and other problems and disadvantages, and to provide at least the advantages described below. Accordingly, an aspect of the present disclosure provides a method and an apparatus which can more easily share media contents.

In accordance with an aspect of the present disclosure, a method of managing contents includes selecting at least one content; storing the at least one selected content in at least one content sharing server; receiving a user input about the selected contents shared through the content sharing server; and reflecting the user input in the selected contents and displaying the contents.

In accordance with another aspect of the present disclosure, a terminal apparatus includes a display that displays at least one media content; at least one controller; and a memory that stores the at least one media content and at least one program, wherein the at least one program is configured to be executed by the controller and includes a command which selects at least one content, stores the at least one selected content in at least one content sharing server, receives a user input about the selected contents shared through the content sharing server, and reflects the user input in the selected contents and displays the contents.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram schematically illustrating a configuration of a terminal apparatus to which a content managing method is applied according to an embodiment of the present disclosure;

FIG. 2 illustrates an example of a system to which a content managing method is applied according to an embodiment of the present disclosure;

FIG. 3A and 3B are a signal flow diagram illustrating a progress process of a content managing method according to an embodiment of the present disclosure;

FIG. 4 is a flow chart illustrating an operation order of a content managing method according to an embodiment of the present disclosure; and

FIGS. 5A-5D, 6A-6D, 7A-7B, and 8A-8E illustrate examples of a user interface (UI) used in a content managing method according to an embodiment of the present disclosure.

### DETAILED DESCRIPTION

Hereinafter, embodiments of the present disclosure will be described with reference to the accompanying drawings. However, the present disclosure is not restricted or limited by these embodiments. The same reference numerals represented in each of the drawings indicate elements that perform substantially the same functions.

Although the terms including an ordinal number such as first, second, etc. can be used for describing various elements, the structural elements are not restricted by the terms. The terms are only used to distinguish one element from another element. For example, without departing from the scope of the present disclosure, a first structural element may be referred to as a second structural element. Similarly, the second structural element also may be referred to as the first structural element. The terms used in this application are for the purpose of describing particular embodiments only and are not intended to limit the disclosure. As used herein, the singular forms are intended to include the plural forms as well, unless the context clearly indicates otherwise.

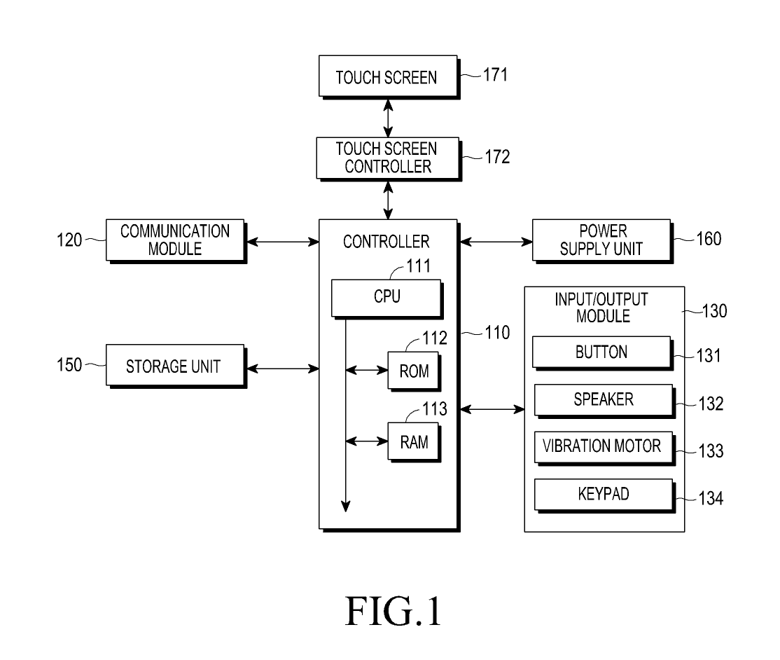

FIG. 1 is a block diagram schematically illustrating a configuration of a terminal apparatus to which a content managing method is applied according to an embodiment of the present disclosure.

Referring to FIG. 1, a terminal apparatus includes a controller 110, a communication module 120, an input/output module 130, a storage unit 150, a power supply unit 160, a touch screen 171, and a touch screen controller 172.

The controller 110 may include a CPU 111, a Read Only Memory (ROM) 112 storing a control program for controlling the terminal apparatus, and a Random Access Memory (RAM) 113 used as a storage area for storing a signal or data input from the outside of the terminal apparatus or for an operation performed by the terminal apparatus. The CPU 111, the ROM 112 and the RAM 113 may be connected with each other through internal buses. Also, the controller 110 may control the communication module 120, the input/output module 130, the storage unit 150, the power supply unit 160, the touch screen 171, and the touch screen controller 172. Further, the controller 110 may include a single-core processor, or may include multiple processors, such as a dual-core processor, a triple-core processor, a quad-core processor, and the like. It goes without saying that the number of cores may be variously determined according to characteristics of the terminal by those having ordinary knowledge in the technical field of the present disclosure.

The controller 110 allows a user to select media contents to be uploaded to a content sharing server and upload the media contents to the content sharing server. Further, the controller 110 receives information on a user input from the content sharing server and stores the information on the user input by interworking with corresponding media content. When the media content is displayed, the information on the user input stored by interworking with the media content can be displayed together.

The communication module 120 may include at least one of a cellular module, a wireless LAN module, and a short-range communication module.

The cellular module enables the terminal apparatus to be connected with an external device through mobile communication by using one antenna or a plurality of antennas according to a control of the controller 110. The cellular module transmits/receives a wireless signal for a voice call, a video call, a Short Message Service (SMS), or a Multimedia Message Service (MMS) to/from a mobile phone, a smart phone, a tablet Personal Computer (PC), or another device having a phone number input into the terminal apparatus.

According to the control of the controller 110, the wireless LAN module may be connected to the Internet at a place where a wireless Access Point (AP) is installed. The wireless LAN module supports the wireless LAN provision (IEEE802.11x) of the Institute of Electrical and Electronics Engineers (IEEE). The wireless LAN module may operate a Wi-Fi Positioning System (WPS) which identifies location information of a terminal including the wireless LAN module by using position information provided by a wireless access point (AP) to which the wireless LAN module is wirelessly connected.

The short distance communication module corresponds to a module that wirelessly processes short distance communication with the terminal apparatus under the control of the controller 110, and may process communication based on Bluetooth, Infrared Data Association (IrDA) communication, WiFi-Direct communication, or a short distance communication scheme such as Near Field Communication (NFC).

The input/output module 130 may include at least one of a button 131, a speaker 132, a vibration motor 133, a keypad 134, and a stylus pen.

The buttons 131 may be disposed on a front surface, a lateral surface or a rear surface of a housing of the terminal apparatus, and may include at least one of a power/lock button, a volume button, a menu button, a home button, a back button and a search button.

The speaker 132 outputs sounds corresponding to various signals (for example, a wireless signal, a broadcasting signal, and the like) of the cellular module, the wireless LAN module, and the short distance communication module to the outside of the terminal apparatus under to the control of the controller 110. One speaker 132 or a plurality of speakers 132 may be formed on a suitable position or positions of the housing of the terminal apparatus.

The vibration motor 133 converts an electrical signal into a mechanical vibration under the control of the controller 110. One vibration motor 133 or a plurality of vibration motors 133 may be formed within the housing of the terminal apparatus.

The speaker 132 and the vibration motor 133 may operate according to a setting state of a volume operation mode of the terminal apparatus. For example, the volume operation mode of the terminal apparatus may include a sound mode, a vibration mode, a sound/vibration mode, and a mute mode. The controller 110 may output a signal instructing the speaker 132 or the vibration motor 133 to execute an operation thereof according to a function performed by the terminal apparatus based on the configured mode of the volume operation mode.

The keypad 134 receives a key input from the user to control the terminal apparatus. The keypad 134 includes a physical keypad formed in the terminal apparatus or a virtual keypad displayed on the touch screen 171. The physical keypad formed in the terminal apparatus may be excluded according to a capability or structure of the terminal apparatus.

The stylus pen may provide a signal which can detect a touch input of the touch screen 171. As the stylus pen approaches or contacts the touch screen 171, the touch screen 171 may detect a signal provided by the stylus pen.

The storage unit 150 stores signals or data input/output in response to the operation of the communication module 120, the input/output module 130, or the touch screen 171 under the control of the control unit 110. The storage unit 150 may store a control program and applications for controlling the terminal apparatus or the controller 110.

The term “storage unit” includes the storage unit 150, the ROM 112 and the RAM 113 within the controller 110, or a memory card (for example, an SD card or a memory stick) installed in terminal apparatus. The storage unit may include a non-volatile memory, a volatile memory, a hard disc drive (HDD) or a solid state drive (SSD).

The power supply unit 160 supplies power to a battery or a plurality of batteries arranged in the housing of the terminal apparatus 100 under the control of the controller 110. The one or more batteries supply power to the terminal apparatus. Further, the power supply unit 160 may supply power input from an external power source to the terminal apparatus through a wired cable connected to a connector included in the terminal apparatus. In addition, the power supply unit 160 may supply power wirelessly input from the external power source through a wireless charging technology to the terminal apparatus.

The touch screen 171 displays a user interface (UI) corresponding to various services (for example, a call, data transmission, and the like) to the user based on an Operating System (OS) of the terminal. The touch screen 171 may transmit an analog signal corresponding to at least one touch, which is input to the UI, to the touch screen controller 172. The touch screen 171 may receive at least one touch as input from the user's body part (e.g., fingers) or an input means (e.g., the stylus pen) enabling a touch.

The touch screen 171, for example, may be implemented in a resistive type, a capacitive type, an infrared type, or an acoustic wave type.

The touch screen controller 172 controls an output value of the touch screen 171 so as to enable display data provided by the controller 110 to be displayed on the touch screen 171. Then, the touch screen controller 172 converts an analog signal received from the touch screen 171 into a digital signal (e.g., X and Y coordinates), and provides the digital signal to the controller 110. The controller 110 may control the touch screen 171 by using the digital signal received from the touch screen controller 172. For example, the controller 110 allows a user to select or execute a shortcut icon displayed on the touch screen 171 in response to a touch event or a hovering event. Further, the touch screen controller 172 may be included in the controller 110.

Hereinafter, the methods according to embodiments of the present disclosure may be implemented in a program command type which may be executed through various computing means, and may be recorded in a computer readable medium. The computer readable medium may include a program command, a data file, a data structure, and the like, independently or in combination. The program instructions recorded in the medium may be specially designed and configured for the present disclosure, or may be known to and usable by those skilled in the field of computer software.

Further, embodiments of the present disclosure may be implemented in a type of a program command and stored in the storage unit 150 of the terminal apparatus, and the program command may be temporarily stored in the RAM 113 included in the controller 110 to execute the methods according to the embodiments of the present disclosure. Accordingly, the controller 110 may control hardware components included in the terminal apparatus in accordance with the program command based on the methods according to the embodiments of the present disclosure, temporarily or continuously store data generated while the methods according to the embodiments of the present disclosure are executed in the storage unit 150, and provide a UI required for executing the methods according to the embodiments of the present disclosure to the touch screen controller 172.

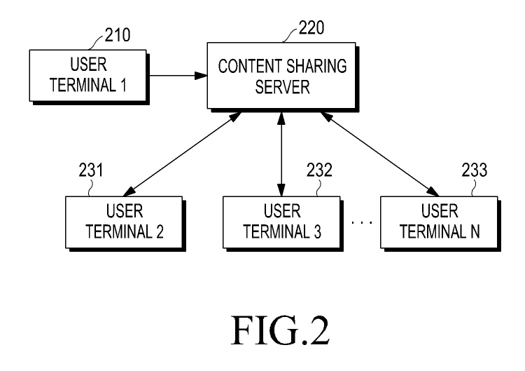

FIG. 2 illustrates an example of a system to which a content managing method is applied according to an embodiment of the present disclosure. Referring to FIG. 2, the system includes a plurality of user terminals 210, 231, 232, and 233 and a content sharing server 220. The plurality of user terminals 210, 231, 232, and 233 may be respectively used by a plurality of users. For example, the user terminal 210 is used by a first user, the second user terminal 231 is used by a second user, the third user terminal 232 is used by a third user, and the n-th user terminal 233 is used by a n-th user. However, in another embodiment of the present disclosure, the plurality of user terminals 210, 231, 232, and 233 are respectively used by one user.

The plurality of user terminals 210, 231, 232, and 233 may store contents in the content sharing server 220 and the content sharing server 220 may provide the stored content to a user who wants the content through the plurality of user terminals 210, 231, 232, and 233. For example, the content sharing server 220 may provide a service which can share media contents between users such as a social media service, for example, Facebook, Twitter, Google+, Tumblr, Flickr, or the like. The content sharing server 220 may manage information on a user account which uses the service. The information on the user account may basically include a user account identifier which identifies the user and an identifier of a user terminal which the user uses and further include user profile information which is used for a recommendation of another user relating to the user.

The content sharing server 220 may store media contents uploaded through the user terminals 210, 231, 232, and 233 by the user based on the user account. In addition, the content sharing server 220 uses the user account to enable another user (or user terminals 210, 231, 232, and 233), whom the user allows to share the contents, to access the media contents. For example, the user may configure a user allowed to share the contents while uploading media contents to the content sharing server 220. Based on the configuration, the content sharing server 220 may provide a sharing service for the media contents.

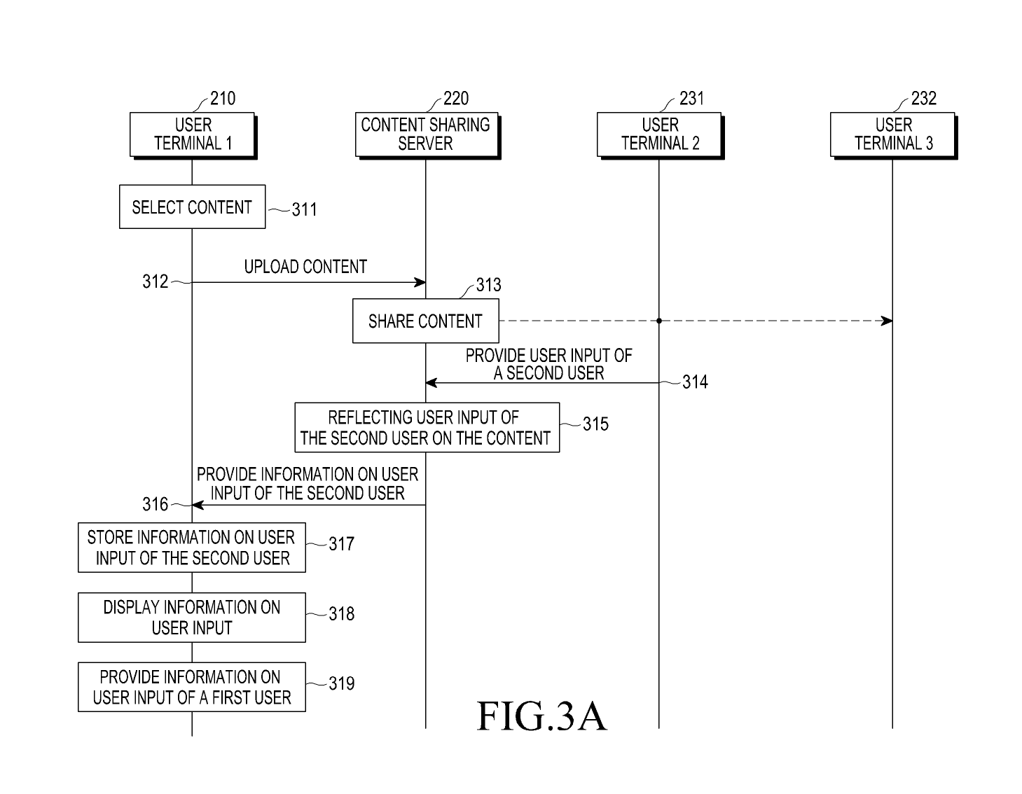

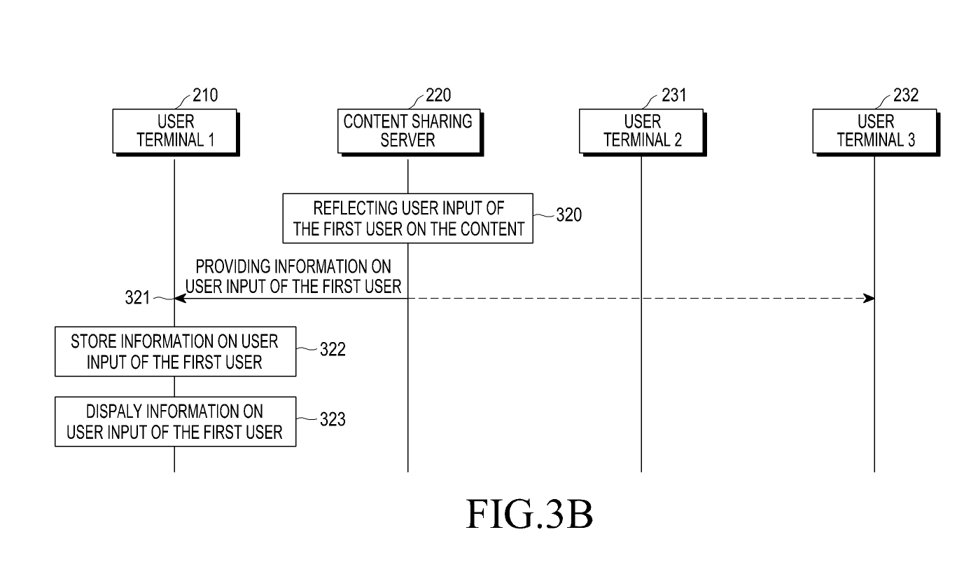

FIG. 3A and 3B are a signal flow chart illustrating a progress process of a content managing method according to an embodiment of the present disclosure. Referring to FIG. 3A, a first user terminal 210 allows a first user to select media contents to be uploaded to the content sharing server 220 by a first user in operation 311. Next, the user terminal 210 uploads the media contents to the content sharing server 220 and stores the media contents in operation 312. In response, the content sharing server 220 provides the media contents to a user terminal (e.g., a second user terminal 231, a third user terminal 232) of a user allowed to share the contents in operation 313. Furthermore, when the media contents to be shared have been stored, the content sharing server 220 may notify a user terminal of a user allowed to store the contents that the media contents are uploaded, through a push alarm, or the like.

Meanwhile, a second user's input relating to the media contents is received through a user terminal (e.g., the second user terminal 231 of the second user) of one user among the users allowed to share the media contents, and then provides the user input to the content sharing server 220 in operation 314. Therefore, the content sharing server 220 reflects the user input in media contents corresponding to the second user's user input in operation 315. For example, the user input may be information including a comment (or reply) for the media contents. Further, the user input may be an input indicating a user's interest (e.g., a “Like” display input) displaying an interest in the media contents.

Next, the content sharing server 220 provides information on the second user's input to the first user terminal 210, which the uploads media contents in operation 316. In this event, the information on the user input may include information indicating that the user input for the media contents occurs. For example, when the second user's user input is a comment (or reply) for the media contents, the information on the second user's user input may include information indicating that a comment (or reply) for the media contents has occurred, a second user's identifier of a user who inputs a comment (or reply), and a content of a comment (or reply) for the media content. In addition, when the second user's user input is an input (e.g., the “Like” display input) displaying an interest in the media contents, the information on the second user's user input may include information indicating that an input (e.g., the “Like” display input) expressing an interest in the media contents has occurred and an identifier of a second user who inputs an input (e.g., the “Like” display input) expressing an interest.

In response, the first user terminal 210 stores information on the user input by interworking with a corresponding media content in operation 317. In addition, that the information on the user input by interworking with the media content has been stored may be displayed through a display of the user terminal 210 using an alarm function, or the like in operation 318.

Further, a first user identifies information on the second user's input and performs an additional input for the identified information. Therefore, the first user terminal 210 receives a user input relating to the media contents and provides the received contents to the content sharing server 220 in operation 319.

In addition, referring to FIG. 3B, the content sharing server 220 reflects the user input in a media content corresponding to a first user's input in operation 320. For example, the first user's input may be information including a comment (or reply) for the media content. Further, the first user's input may be an input indicating an interest (e.g., the “Like” display input) displaying an interest in a comment (or reply) which another user inputs.

Next, the content sharing server 220 provides the information on the first user's input to the first user terminal 210 and another user terminal (e.g., the second user terminal 231, the third user terminal 232, or the like) in operation 321. In this event, the information on the user input may include information indicating that a user input for the media content is generated. For example, when the first user's input is a comment (or reply) for the media content, the information on the first user's input may include information indicating that the comment (or reply) for the media content is generated, an identifier of a first user who inputs the comment (or reply), and a content of the comment (or reply) for the media content. Also, when the first user's input is an interest input (e.g., the “Like” display input) displaying an interest in a comment (or reply) which another user inputs, the information on the first user's input may include an identifier of the comment (or reply) which another user inputs, information indicating an interest input (e.g., the “Like” display input) displaying an interest in the comment (or reply) which another user inputs, and an identifier of the first user who inputs an input (e.g., the “Like” display input) expressing an interest.

Then, the first user terminal 210 stores information on the first user input of the first user and displays information of the first user input in operation 322 and 323.

In the embodiment of the present disclosure as described above, operations 319 to 322 are performed after operations 314 to 317, but the present disclosure is not limited thereto. In another embodiment of the present disclosure, it goes without saying that operation 319 to 322 can be performed regardless of whether operations 314 to 317 have been performed.

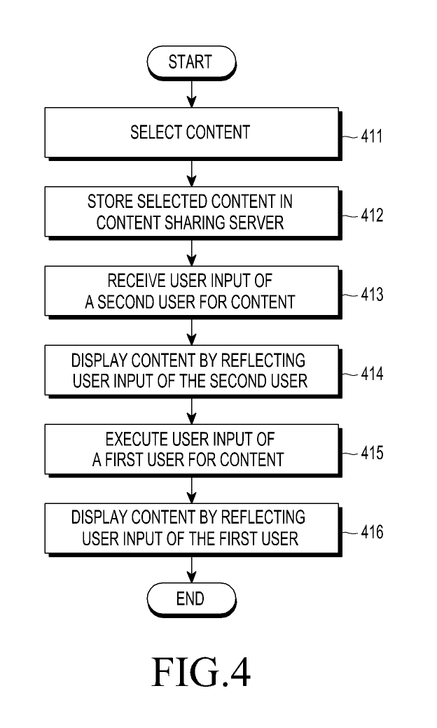

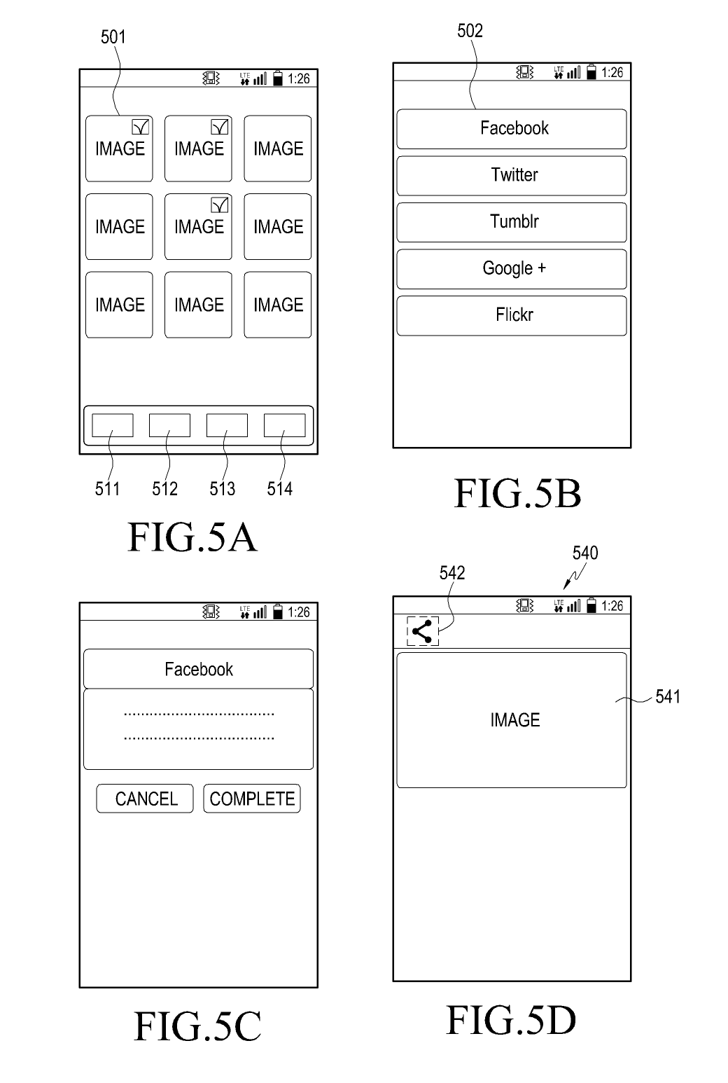

FIG. 4 is a flow chart illustrating an operation order of a content managing method according to an embodiment of the present disclosure and FIGS. 5A-5D, 6A-6D, 7A-7B, AND 8A-8E illustrate examples of a user interface (UI) used in a content managing method according to an embodiment of the present disclosure.

An operation order of a content managing method as shown in FIG. 4 is an example of an operating process on a side of a user terminal (e.g., a first user) which uploads media contents as illustrated in FIGS. 2 and 3.

First, in step 411, the controller 110 included in the user terminal 210 allows a user to select media contents shared through the content sharing server 220. In step 411, an operation of an application which provides a function of watching or searching the media contents through a menu or a UI provided by the user terminal 210 may be disclosed. For example, the media contents may be images. In addition, the user terminal receives an input of execution of an image viewer application from the user so that the controller 110 may execute the image viewer application and display an image viewer UI as illustrated in FIG. 5A. Further, the controller 110 selects a corresponding image by detecting a touch input event corresponding to an area where the images 501 are displayed, in a state in which the images 501 are displayed through the image viewer UI. Furthermore, the controller 110 may mark a corresponding image to allow the user to recognize a selected image through the process. For example, the controller 110 may overlap and display a check (✓) mark on a part of the corresponding image or shade and display a corresponding image with a predetermined level so as to distinguish the corresponding image from another image which is not selected.

The image viewer UI may include a predetermined soft key for processing the selected image. The soft key may include a delete key 511, a copy key 512, a move key 513, and a share key 514.

In another embodiment as illustrated in FIG. 5D, the image viewer UI 540 may display one image 541 and the share key 542. The controller 111 may select and share the image 541 by detecting a touch input event corresponding to an area where the share key 514 is displayed.

Next, the controller 110 proceeds to step 412 in response to an input of the sharing key 514. In step 412, the controller 110 progresses to an operation of uploading the selected media contents (e.g., images) to the content sharing server 210 and then storing the selected media contents. For example, as illustrated in FIG. 5B, a server which provides a service 502 of storing and sharing the selected media contents (e.g., images) is chosen as a content sharing server. Then, the controller 110 provides a content upload UI (referring to FIG. 5C) provided in the selected service and transmits the selected media contents (e.g., images) to the corresponding content sharing server 210 together with information input by the content upload UI so as to request sharing the selected media contents. In response, the content sharing server 210 identifies user information (e.g., account information) corresponding to the user terminal and stores the selected media contents (e.g., images).

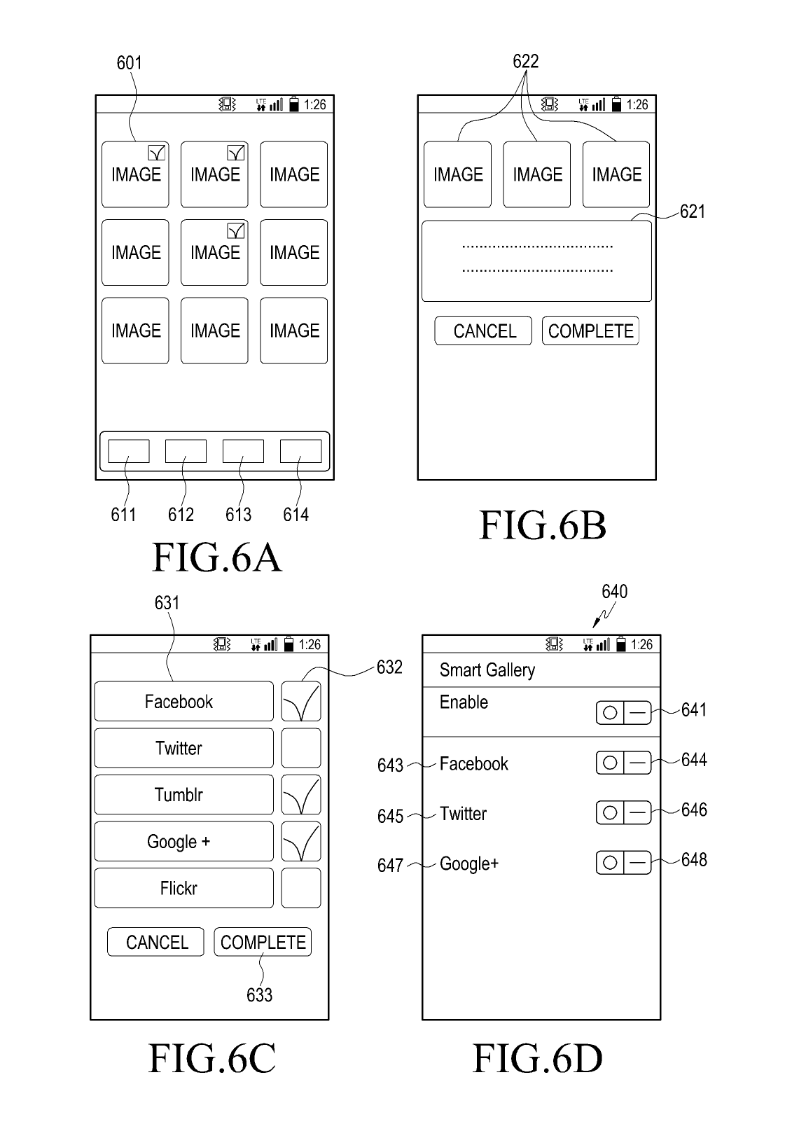

Furthermore, according to an embodiment of the present disclosure, while it has been illustrated that the service 502 which stores and shares one media content (e.g., an image) is selected and the selected media content (e.g., the image) is stored to one corresponding content sharing server 210, the present disclosure is not limited thereto. For example, a plurality of the services 502 which store and share the media content (e.g., images) are selected and the selected media content (e.g., the image) may be stored in a plurality of corresponding content sharing servers 210. To this end, as illustrated in FIG. 6A, the controller 110 may display at least one image 601 and provide an image viewer UI including a soft key such as a delete key 611, a copy key 612, a move key 613, and a share key 614. Further, the controller 110 selects a corresponding image by detecting a touch input event corresponding to an area where the images 601 are displayed, in a state in which the images 601 are displayed through the image viewer UI. Further, the controller 110 provides a content upload UI (referring to FIG. 6B) provided in the selected service in response to an input of the sharing key 614. The content upload UI (referring to FIG. 6B) may include a data input window 621 which can receive an input of predetermined data (e.g., text data) stored together with the selected media contents (e.g., images). In addition, the content upload UI of FIG. 6B may further include a content display window 622 which summarizes and displays the selected media contents (e.g., images), for example, displays a thumbnail image of the selected image. When an input for the predetermined data (e.g., text data) has been completed through the content upload UI of FIG. 6B, the controller 110 provides a sharing service selection UI as illustrated in FIG. 6C. The sharing service selection UI may include a service identification list 631 where information identifying a sharing service is displayed, a service selection input tap 632 interworking with the service identification list 631, and a complete key 633 for indicating completion of the selection. The controller 110 selects the content sharing server 220 to store the selected media contents (e.g., images) through the sharing service selection UI and request to store the selected media contents (e.g., images) to a corresponding content sharing server 220.

In addition, in another embodiment, at least one selected media content (e.g., images) may be included to be automatically stored and shared to the content sharing server 220. For example, through a content sharing configuration UI 640 illustrated in FIG. 6D, the service 502 which stores and shares the contents can be previously configured and the media contents (e.g., images) may be configured to be automatically shared. The content sharing configuration UI 640 may include a content sharing configuration key 641 which inputs whether the contents are shared. The content sharing configuration key 641 may be used to configure whether on the at least one media contents (e.g., images) and enable to the terminal apparatus to receive an input on whether the one or more media contents (e.g., images) are configured to be shared. When input that the sharing of one or more the media content (e.g., images) is configured has been received, service selection keys 644, 646, and 648 which can select the service 502 of storing and sharing the media contents (e.g., images) are displayed as submenus thereof. The service selection keys 644, 646, and 648 may include the service identifiers 643, 645, and 647 identifying a service and service sharing selection keys 644, 646, and 648 permit input as to whether the media contents (e.g., images) are shared with a corresponding service 502. For example, the service selection keys may include a first service identifier (e.g., Facebook) 643, a first service sharing selection key 644 corresponding to the first service identifier (e.g., Facebook) 643, a second identifier (e.g., Twitter) 645, a second service sharing selection key 646 corresponding to the second identifier (e.g., Twitter) 645, a third identifier (e.g., Google+) 647, and a third service sharing selection key 648 corresponding to the third identifier (e.g., Google+) 647. Therefore, a user may respectively identify the service identifiers 643, 645, and 647 and input whether the media contents (e.g., images) are shared with a corresponding service 502 using the service sharing selection keys 644, 646, and 648. Further, the controller 110 may identify input values of the service sharing selection keys 644, 646, and 648 and identify whether the media contents (e.g., images) are shared with a corresponding service 502. Also, as it has been identified that the media contents (e.g., images) are shared with the corresponding service 502, the controller 110 may transmit the media contents (e.g., images) to the content sharing server 220 which manages the corresponding service 502.

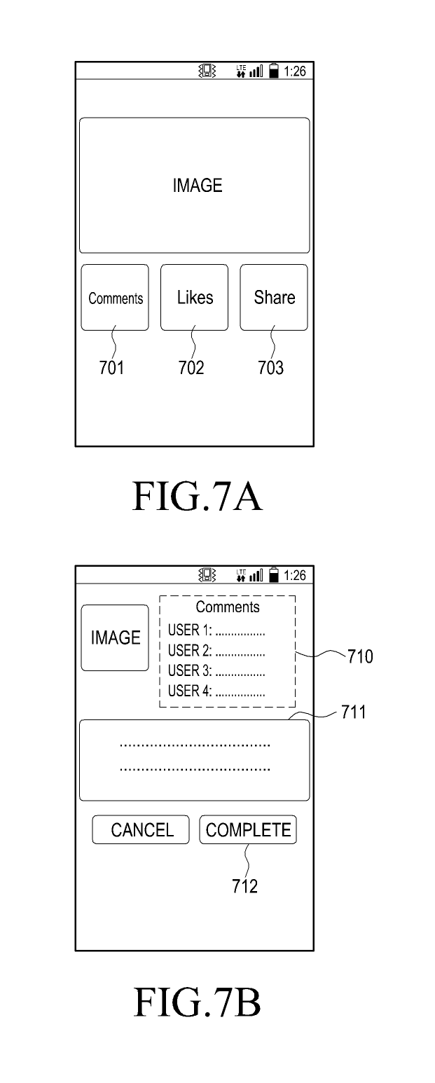

Meanwhile, as illustrated in operation 313 of FIG. 3, the content sharing server 220 provides the selected media contents (e.g., images) to a user terminal (e.g., the second user terminal 231, the third user terminal 232) of a user allowed to share the contents. In response, the user terminal (e.g., the second user terminal 231, the third user terminal 232) of the user allowed to share the contents may be provided with the shared media contents (e.g., images) through an application (e.g., a social media application such as Facebook, Twitter, Google+, Tumblr, and Flickr) provided in the content sharing server 220. For example, the user terminal (e.g., the second user terminal 231, the third user terminal 232) of the user allowed to share the contents may provide the shared media contents (e.g., images) through a social media UI within a social media application as illustrated in FIG. 7A. Further, the social media UI may include a comment key 701 requesting a comment (or reply) input for the shared media contents (e.g., images), an interest input key 702 inputting an interest (e.g., a “Like”) in the shared media contents (e.g., images), and a sharing key 703 for sending a request for sharing the shared media contents (e.g., images) to another user.

In the social media UI, when the comment key 701 has been input, the user terminal (e.g., the second user terminal 231, the third user terminal 232) of the user allowed to share the contents may provide a comment UI including a comment display 710 displaying a previously input comment about the shared media contents (e.g., images), a comment input window 711 which can receive an input a comment, and a complete key 712 which can complete the comment input. When a comment relating to the shared media contents (e.g., images) has been input by the user through the comment UI and the complete key 712 has been input, the user terminal 231 or 232 transmits the input comment to the content sharing server 220.

When the interest input key 702 is input within the social media UI, the user terminal 231 or 232 transmits an interest input by the user to the content sharing server 220. Furthermore, the user terminal 231 or 232 may display the interest input through an operation of changing a color on the interest input key 702 included in the social media UI, or the like, in response to an interest input by the user.

Meanwhile, the content sharing server 220 identifies a user input (i.e., comment or interest input) received from the user terminal 231 or 232 and provides information on the user input to the first user terminal 210. In this event, the information on the user input may include information indicating that the user input for the media contents has occurred. For example, when the user input is a comment (or reply) for the media contents, the information on the user input may include information indicating that a comment (or reply) for the media contents has occurred, an identifier of a user who inputs a comment (or reply), and a content of a comment (or reply) for the media content. In addition, when the user input is the interest input (e.g., a “Like”), the information on the user input may include information indicating that the interest input has occurred and an identifier of a user who inputs the interest input.

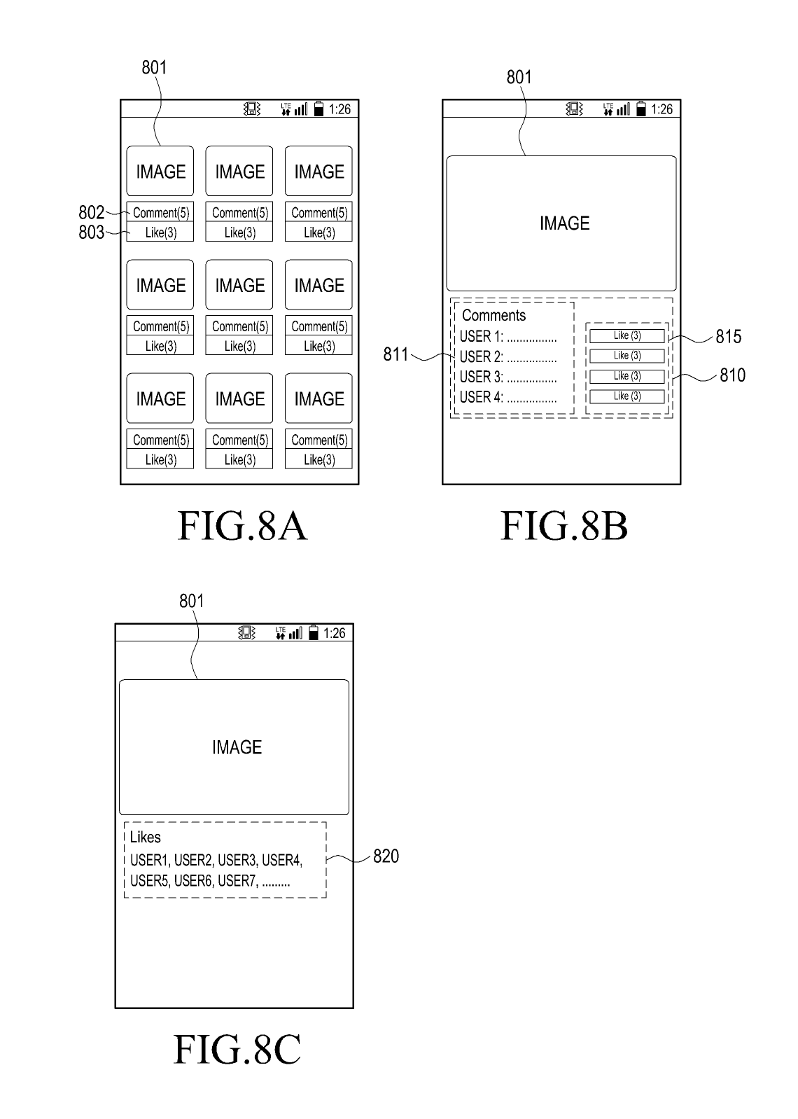

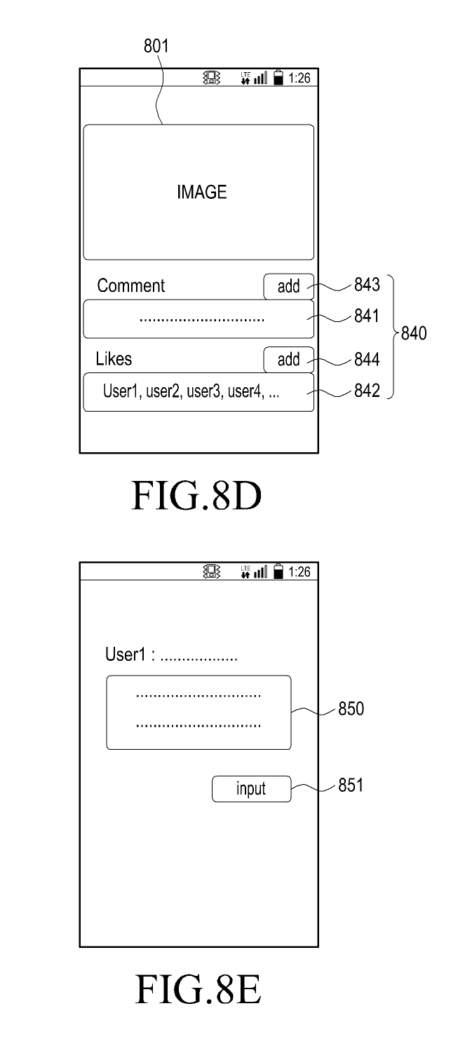

In response, the controller 110 included in the first user terminal 210 stores the information on the user input by interworking with a corresponding media content. In addition, as illustrated in FIG. 8A, the controller 110 may display an image 801 through the image viewer UI and display information 802 and 803 on the user input together with a corresponding image. For example, information on the user input, e.g., comment information 802 and interest input information 803 may be displayed at the bottom of the displayed image 801. Further, according to another example, the comment information 802 and the interest input information 803 can be displayed by overlapping the image 801. Furthermore, the comment information 802 and the interest input information 803 may be displayed while simply including information on the number of comments and the number of interest inputs. The information on the number of comments and the number of interest inputs may include the number of all comments relating to the image and the number of all interest inputs. Similarly, the information on the number of comments and the number of interest inputs may also include the number of comments which the user has not identified and the number of interest inputs which the user has not identified.

Meanwhile, as a touch input event is generated by the user on an area where the comments information 802 is displayed, the controller 110 progresses to an operation of displaying the comment information 802. For example, the controller 110 displays a comment display UI illustrated in FIG. 8B on the touch screen 171. The comment display UI may include a comment window 810 which displays a corresponding image 801 and a detailed content 811 of the comment information on the image 801.

The detailed content of the comment information may include an identifier of a user who inputs the comment (e.g., a user name, a user account ID, or the like) and content of the comment. Furthermore, since the media contents may be stored and managed in a plurality of content sharing servers 220, the detailed content of the comment information may include an identifier which can identify the particular content sharing server 220 and, preferably, the identifier which can identify the content sharing server 220 may be a service identifier (e.g., a service name such as Facebook, Twitter, Google+, Tumblr, Flickr, or the like) which identifies a service provided through the content sharing server 220. The comment display UI is included in an image viewer application and may display the comment information corresponding to the media contents (e.g., images) without performing an application provided in a service where the media contents are shared.

In addition, as a touch input event is generated by the user on an area where the interest input information 803 is displayed, the controller 110 progresses to an operation of displaying the interest input information 803. For example, the controller 110 displays an interest input display UI illustrated in FIG. 8C on the touch screen 171. The interest input display UI may include a corresponding image 801 and an interest input display window 820 which displays the detailed content about an interest input relating to the image 801, i.e., an identifier (e.g., user name, user account ID, or the like) of a user who inputs the interest input. Furthermore, since the detailed content of the interest input information may be stored and managed in a plurality of content sharing servers 220, the detailed content of the interest input information may include an identifier which can identify the particular content sharing server 220 and, preferably, the identifier which can identify the content sharing server 220 may be a service identifier (e.g., a service name such as Facebook, Twitter, Google+, Tumblr, Flickr, or the like) which identifies a service provided through the content sharing server 220. The interest input display UI is included in an image viewer application and may display the interest input information corresponding to the media contents (e.g., images) without performing an application provided in a service where the media contents are shared.

In addition, the comment window 810 illustrated in FIG. 8B may further include comment interest input information 815 displaying interest input information on each comment included in the detailed content 811 of the comment information, together with the detailed content 811 of the comment information. As a touch input event is generated in an area where comment interest input information 815 is displayed, the controller 110 progresses to an operation of displaying the comment interest input information 815. For example, the controller 110 displays a comment interest input display UI 840 illustrated in FIG. 8D on the touch screen 171. The comment interest input display UI 840 may include a corresponding image 801, information 841 on a corresponding comment, e.g., an identifier (e.g., a user name, a user account ID, or the like) of a user who inputs the comment, a content of the comment, or the like, and an interest input display window 842 displaying a detailed content for an interest input relating to the comment, e.g., an identifier (e.g., a user name, a user account ID, or the like) of a user who inputs the interest input, or the like.

Meanwhile, as the controller 110 provides a UI, or the like, as illustrated in FIGS. 8A to 8D, a first user may identify comment information on the media contents (e.g., images), interest input information, or the like. Further, the first user may input additional information in comment information on the media contents, interest input information, or the like. For example, the controller 110 displays a comment display UI illustrated in FIG. 8B as a touch input event is generated in an area where the comment information 802 of the image viewer UI of FIG. 8A is displayed by a user, and the controller 110 may display a comment interest input display UI 840 connected to a comment (e.g., a first comment) corresponding to an area, where a touch input occurs, in the comment display UI, as a touch input event is generated in an area where the comment window 810 is displayed. Furthermore, the comment interest input display UI 840 may further include an additional comment input key 843 which can add a user input for the first comment and a comment interest input key 844 which can add an interest input for the first comment, as shown in FIG. 8D.

As shown in FIG. 8E, as a touch input event is generated in an area where the additional comment input key 843 is displayed, the controller 110 may provide the additional comment input window 850 and process information input in the additional comment input window 850 as an input key 851 has been input after a predetermined text has been input in the additional comment input window 850. For example, the controller 110 may provide (transmit) information input through the additional comment input window 850 to the content sharing server 220. Further, the information input through the additional comment input window 850 is connected to the first comment and stored so that the information transmitted to the content sharing server 220 may include information on the first comment. The information on the first comment may include a service identifier (e.g., a service name such as Facebook, Twitter, Google+, Tumblr, Flickr, or the like) which identifies a service where the first comment is generated and information (e.g., account information) identifying a user who inputs the first comment.

As a touch input event is generated in an area where the comment interest input key 844 is displayed, the controller 110 processes comment interest input information. For example, the controller 110 may provide information indicating the comment interest input to the content sharing server 220. In this event, the comment interest input is connected to the first comment and stored so that the information transmitted to the content sharing server 220 may include information on the first comment. For example, the information on the first comment may include information identifying the first comment, a service identifier (e.g., a service name such as Facebook, Twitter, Google+, Tumblr, Flickr, or the like) which identifies a service where the first comment is generated and information (e.g., account information) identifying a user who inputs the first comment.

Meanwhile, referring back to FIG. 4, after the information input or the comment interest input information through the additional comment input window 850 is transmitted to the content sharing server 220, the controller 110 may reflect information input through the additional comment input window 850 or the comment interest input information in the media contents (e.g., images) and then provide the media contents, as information input through the additional comment input window 850 from the content sharing server 220 or information indicating that the comment interest input information has normally been stored has been received, in step 416.

As described above, in a content managing method according to an embodiment of the present disclosure, even though the user terminal 210 is not connected to the content sharing server 220 where the media contents (e.g., images) are stored, the user terminal 210 may display the comment information and the interest input information by using pre-stored information on the user input. Further, without performing an application provided in a service sharing the media contents, information (e.g., a comment, an interest input, or the like) on a user input stored in a terminal is directly displayed in the media contents (e.g., images) so that a user can conveniently identify more quickly information on the user input. Since an application provided in the service sharing the media contents does not need to be performed whenever information on the user input (e.g., comment, interest input, or the like) is displayed, repeatedly performing an operation of a corresponding application can be reduced and power consumption of the user terminal can be reduced.

It will be appreciated that the embodiments of the present disclosure may be implemented in a form of hardware, software, or a combination of hardware and software. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. A web widget manufacturing method of the present disclosure can be realized by a computer or a portable terminal including a controller and a memory, and it can be seen that the memory corresponds to an example of the storage medium which is suitable for storing a program or programs including instructions by which the embodiments of the present disclosure are realized, and is machine readable. Accordingly, the present disclosure includes a program for a code implementing the apparatus and method described in the appended claims of the specification and a machine (a computer or the like)-readable storage medium for storing the program. Further, the program may be electronically transferred by a predetermined medium such as a communication signal transferred through a wired or wireless connection, and the present disclosure appropriately includes equivalents of the program.

Further, the device can receive the program from a program providing apparatus connected to the device wirelessly or through a wire and store the received program. The program providing apparatus may include a program with instructions to perform a contents protecting method, a memory for storing information necessary for the contents protecting method, a communication unit for performing a wired or wireless communication, and a controller for controlling a transmission of the program. The program providing apparatus may provide the program to the terminal apparatus when receiving a request for providing the program from the terminal apparatus. Further, even when there is no request for providing the program from the terminal apparatus, for example, when the terminal apparatus is located within a particular place, the program providing apparatus may provide the program to the terminal apparatus through a wire or wirelessly.

While the disclosure has been shown and described with reference to certain embodiments thereof, it will be understood by those skilled in the art that various changes in form and detail may be made therein without departing from the spirit and scope of the invention as defined by the appended claims and their equivalents.

1. A method of managing contents comprising:
selecting at least one content;
storing the at least one selected content in at least one content sharing server;
receiving a user input about the selected contents shared through the content sharing server; and
reflecting the user input in the selected contents and displaying the contents.

2. The method of claim 1, wherein the user input comprises comment data input related to the contents.

3. The method of claim 1, wherein the user input comprises an interest input related to the contents.

4. The method of claim 1, wherein reflecting the user input in the selected contents and displaying the contents further comprises displaying a User Interface (UI) which displays at least one content and information on a user input corresponding to the contents.

5. The method of claim 4, wherein the information on the user input comprises a number of times by-which the user input has occurred.

6. The method of claim 4, wherein reflecting the user input in the selected contents and displaying of the contents comprises:
receiving a selection of a user input corresponding to the contents; and
displaying detailed information of a user input corresponding to a content in response to the selection.

7. The method of claim 6, wherein the detailed information of the user input comprises a detailed content of comment data input related to to the contents.

8. The method of claim 7, wherein the detailed information of the user input further comprises a service identifier which identifies a service provided in the at least one content sharing server.

9. The method of claim 7, wherein the detailed information of the user input comprises an identifier of a user who inputs an interest input on the contents.

10. A terminal apparatus comprising:
a display that displays at least one media content;
at least one controller; and
a memory that stores the at least one media content and at least one program,
wherein the at least one program is configured to be executed by the controller and comprises a command which selects at least one content, stores the at least one selected content in at least one content sharing server, receives a user input about the selected contents shared through the content sharing server, and reflects the user input in the selected contents and displays the contents.

11. The terminal apparatus of claim 10, wherein the user input comprises comment data input related to the contents.

12. The terminal apparatus of claim 10, wherein the user input comprises an interest input related to the contents.

13. The terminal apparatus of claim 10, wherein the at least one program corresponding to a command which the reflects the user input in the selected contents and displays the contents further comprises a command which displays a User Interface (UI) that displays the at least one content and information on a user input corresponding to the contents.

14. The terminal apparatus of claim 13, wherein the information on the user input comprises a number of times which the user input has occurred.

15. The terminal apparatus of claim 13, wherein the at least one program corresponding to a command which reflects the user input in the selected contents and displays of the contents further comprises a command which receives a selection of a user input corresponding to the contents and displays detailed information of a user input corresponding to a content in response to the selection.

16. The terminal apparatus of claim 15, wherein the detailed information of the user input comprises a detailed content of comment data input related to the contents.

17. The terminal apparatus of claim 16, wherein the detailed information of the user input further comprises a service identifier which identifies a service provided in the at least one content sharing server.

18. The terminal apparatus of claim 16, wherein the detailed information of the user input comprises an identifier of a user who inputs an interest input on the contents.
